(19) United States
(12) Patent Application Publication
(10) Pub. No.: US 2016/0066553 A1
(43) Pub. Date: Mar. 10, 2016

(54) CONTROLLED RELEASE OF CARBON DIOXIDE FROM SELF-IMMOLATIVE POLYMERS

(71) Applicant: University of Washington, Seattle, WA (US)

(72) Inventors: Andrew J. Boydston, Seattle, WA (US); Derek C. Church, Seattle, WA (US); Gregory I. Peterson, Seattle, WA (US)

(73) Assignee: UNIVERSITY OF WASHINGTON, Seattle, WA (US)

(21) Appl. No.: 14/850,768

(22) Filed: Sep. 10, 2015

Related U.S. Application Data
(60) Provisional application No. 62/048,505, filed on Sep. 10, 2014.

(51) Int. Cl. A01M 1/02; C01B 31/20; B01D 71/50; B01D 53/22; B01D 71/54

(52) U.S. Cl. CPC A01M 1/023; B01D 53/228; B01D 71/54; B01D 71/50; C01B 31/20

(57) ABSTRACT

The present disclosure is directed to a carbon dioxide-releasing device, including a chamber having a sealable aperture for receiving a first material; a carbon dioxide-releasing polymer disposed within the chamber; and a port for releasing a carbon dioxide generated by the carbon dioxide-releasing polymer from the chamber. The carbon-dioxide releasing polymer can be a self-immolative polymer.

### CROSS-REFERENCE TO RELATED APPLICATION

This application claims the benefit of U.S. Patent Application No. 62/048,505, filed Sep. 10, 2014, the disclosure of which is hereby incorporated by reference in its entirety.

### STATEMENT OF GOVERNMENT LICENSE RIGHTS

This invention was made with Government support under W911NF-11-1-0289, awarded by the U.S. Army Research Office. The Government has certain rights in the invention.

### BACKGROUND

Mosquitoes, ticks, and other biting insects use carbon dioxide (CO₂) as a signaling molecule to direct them to their prey. Thus, CO₂ can be used as an attractant for attracting biting insects into insect traps. However, methods for producing CO₂ generally lack efficient means of regulating and precisely matching CO₂ concentrations that mimic exhalation.

There is presently a need for CO₂-releasing devices and materials that can release CO₂ in a predictable and regulated manner. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, this disclosure features a carbon dioxide-releasing device, including a chamber having a sealable aperture for receiving a first material; a carbon dioxide-releasing polymer disposed within the chamber; and a port for releasing carbon dioxide generated by the carbon dioxide-releasing polymer from the chamber.

In another aspect, this disclosure features a method for making a carbon dioxide-releasing device, including disposing a carbon dioxide-releasing polymer in a chamber having a sealable aperture for receiving a first material and a port for releasing a gas generated by the carbon dioxide-releasing polymer from the chamber.

In yet another aspect, this disclosure features a method of attracting an insect that is attracted to carbon dioxide to a carbon dioxide source, including controllably releasing carbon dioxide from a carbon dioxide source in an environment frequented by an insect attracted to carbon dioxide, thereby attracting the insect to carbon dioxide, wherein the carbon dioxide source is a carbon dioxide-releasing polymer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic representation of an embodiment of a device of the present disclosure.

FIG. 1B is a schematic representation of an embodiment of a device of the present disclosure.

FIG. 2 is a scheme illustrating the depolymerization of polyurethane and polycarbonate-based self-immolative polymers.

FIG. 3 is a scheme illustrating the reactions within an embodiment of a rechargeable device for CO₂ release.

FIG. 4 is a scheme illustrating the CO₂ release from an embodiment of a polyurethane self-immolative polymer with an oxidative trigger.

FIG. 5 is a scheme illustrating the release of CO₂ at various temperatures from an embodiment of a self-immolative polymer-containing diblock copolymer.

### DETAILED DESCRIPTION

The present disclosure is directed to a carbon dioxide-releasing device, including a chamber having a sealable aperture for receiving a first material; a carbon dioxide- releasing polymer disposed within the chamber; and a port for releasing a carbon dioxide generated by the carbon dioxide-releasing polymer from the chamber. The carbon dioxide-releasing polymer can be a self-immolative polymer.

In some embodiments, the carbon dioxide releasing device is used to attract and trap insects. The insects can be biting insects that are attracted to carbon dioxide, such as mosquitos, horse flies, deer flies, black flies, and/or ticks.

The carbon dioxide device can release carbon dioxide over an extended duration, such as from 1 day to 200 days. The carbon dioxide can be released at a steady rate over the duration.

### Definitions

At various places in the present specification, substituents of compounds of the disclosure are disclosed in groups or in ranges. It is specifically intended that the disclosure include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl.

It is further appreciated that certain features of the disclosure, which are, for clarity, described in the context of separate embodiments, can also be provided in combination in a single embodiment.

Conversely, various features of the disclosure which are, for brevity, described in the context of a single embodiment, can also be provided separately or in any suitable subcombination.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Furthermore, references have been made to patents and printed publications throughout this specification. Each of the above-cited references and printed publications are individually incorporated herein by reference in their entirety.

As used herein, the term “substituted” or “substitution” refers to the replacing of a hydrogen atom with a substituent other than H. For example, an “N-substituted piperidin-4-yl” refers to replacement of the H atom from the NH of the piperidinyl with a non-hydrogen substituent such as, for example, alkyl.

Terms used herein may be preceded and/or followed by a single dash, “—”, or a double dash, “═”, to indicate the bond order of the bond between the named substituent and its parent moiety; a single dash indicates a single bond and a double dash indicates a double bond. In the absence of a single or double dash it is understood that a single bond is formed between the substituent and its parent moiety; further, substituents are intended to be read “left to right” unless a dash indicates otherwise. For example, C₁-C₆ alkoxycarbonyloxy and —OC(O)C₁-C₆ alkyl indicate the same functionality; similarly arylalkyl and -alkylaryl indicate the same functionality.

As used herein, the term “alkyl” refers to a straight or branched chain hydrocarbon containing from 1 to 10 carbon atoms, unless otherwise specified. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

As used herein, the term “alkylene” refers to a linking alkyl group. The linking alkyl group can be a straight or branched chain; examples include, but are not limited to —CH₂—, —CH₂CH₂—, —CH₂CH₂CHC(CH₃)—, and —CH₂CH(CH₂CH₃)CH₂—.

As used herein, the term “alkenyl” refers to a straight or branched chain hydrocarbon containing from 2 to 10 carbons, unless otherwise specified, and containing at least one carbon-carbon double bond. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-l-heptenyl, 3-decenyl, and 3,7-dimethylocta-2,6-dienyl.

As used herein, the term “alkenylene” refers to a linking alkenyl group.

As used herein, the term “alkynyl” refers to a straight or branched chain hydrocarbon group containing from 2 to 10 carbon atoms and containing at least one carbon-carbon triple bond. Representative examples of alkynyl include, but are not limited, to acetylenyl, 1-propynyl, 2-propynyl, 3-butynyl, 2-pentynyl, and 1-butynyl.

As used herein, “alkynylene” refers to a linking alkynyl group.

As used herein, “aryl” refers to monocyclic or polycyclic (e.g., having 2, 3 or 4 fused rings) aromatic hydrocarbons such as, for example, phenyl, naphthyl, anthracenyl, phenanthrenyl, indanyl, indenyl, and the like. In some embodiments, aryl groups have from 6 to about 20 carbon atoms.

As used herein, the term “arylene” refers to a linking aryl group.

As used herein, “cycloalkyl” refers to non-aromatic cyclic hydrocarbons including cyclized alkyl, alkenyl, and alkynyl groups. Cycloalkyl groups can include mono- or polycyclic (e.g., having 2, 3 or 4 fused rings) ring systems as well as spiro ring systems. Ring-forming carbon atoms of a cycloalkyl group can be optionally substituted by oxo or sulfido. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcamyl, adamantyl, and the like. Also included in the definition of cycloalkyl are moieties that have one or more aromatic rings fused (i.e., having a bond in common with) to the cycloalkyl ring, for example, benzo or thienyl derivatives of pentane, pentene, hexane, and the like.

As used herein, “cycloalkylene” refers to a linking cycloalkyl group.

As used herein, “heteroalkyl” refers to an alkyl group having at least one heteroatom such as sulfur, oxygen, or nitrogen.

As used herein, “heteroalkylene” refers to a linking heteroalkyl group.

As used herein, “heteroaryl” groups refer to an aromatic heterocycle having at least one heteroatom ring member such as sulfur, oxygen, or nitrogen. Heteroaryl groups include monocyclic and polycyclic (e.g., having 2, 3 or 4 fused rings) systems. Examples of heteroaryl groups include without limitation, pyridyl, pyrimidinyl, pyrazinyl, pyridazinyl, triazinyl, furyl, quinolyl, isoquinolyl, thienyl, imidazolyl, thiazolyl, indolyl, pyrryl, oxazolyl, benzofuryl, benzothienyl, benzthiazolyl,isoxazolyl, pyrazolyl, triazolyl, tetrazolyl, indazolyl, 1,2,4-thiadiazolyl, isothiazolyl, benzothienyl, purinyl, carbazolyl, benzimidazolyl, indolinyl, and the like. In some embodiments, the heteroaryl group has from 1 to about 20 carbon atoms, and in further embodiments from about 3 to about 20 carbon atoms. In some embodiments, the heteroaryl group contains 3 to about 14, 3 to about 7, or 5 to 6 ring-forming atoms. In some embodiments, the heteroaryl group has 1 to about 4, 1 to about 3, or 1 to 2 heteroatoms.

As used herein, “heteroarylene” refers to a linking heteroaryl group.

As used herein, “heterocycloalkyl” refers to non-aromatic heterocycles including cyclized alkyl, alkenyl, and alkynyl groups where one or more of the ring-forming carbon atoms are replaced by a heteroatom such as an O, N, or S atom. Heterocycloalkyl groups can be mono- or polycyclic (e.g., having 2, 3, 4 or more fused rings or having a 2-ring, 3-ring, 4-ring spiro system (e.g., having 8 to 20 ring-forming atoms). Heterocycloalkyl groups include monocyclic and polycyclic groups. Example “heterocycloalkyl” groups include morpholino, thiomorpholino, piperazinyl, tetrahydrofuranyl, tetrahydrothienyl, 2,3-dihydrobenzofuryl, 1,3-benzodioxole, benzo-I,4-dioxane, piperidinyl, pyrrolidinyl, isoxazolidinyl, isothiazolidinyl, pyrazolidinyl, oxazolidinyl, thiazolidinyl, imidazolidinyl, and the like. Ring-forming carbon atoms and heteroatoms of a heterocycloalkyl group can be optionally substituted by oxo or sulfido. Also included in the definition of heterocycloalkyl are moieties that have one or more aromatic rings fused (i.e., having a bond in common with) to the nonaromatic heterocyclic ring, for example phthalimidyl, naphthalimidyl, and benzo derivatives of heterocycles such as indolene and isoindolene groups. In some embodiments, the heterocycloalkyl group has from 1 to about 20 carbon atoms, and in further embodiments from about 3 to about 20 carbon atoms. In some embodiments, the heterocycloalkyl group contains 3 to about 14, 3 to about 7, or 5 to 6 ring-forming atoms. In some embodiments, the heterocycloalkyl group has 1 to about 4, 1 to about 3, or 1 to 2 heteroatoms. In some embodiments, the heterocycloalkyl group contains 0 to 3 double bonds. In some embodiments, the heterocycloalkyl group contains 0 to 2 triple bonds.

As used herein, “alkoxy” refers to an —O-alkyl group. Example alkoxy groups include methoxy, ethoxy, propoxy (e.g., n-propoxy and isopropoxy), t-butoxy, and the like.

As used herein, “aryloxy” refers to an —O-aryl group. Example aryloxy groups include phenyl-O—, substituted phenyl-O—, and the like.

As used herein, “arylalkyl” refers to alkyl substituted by aryl and “cycloalkylalkyl” refers to alkyl substituted by cycloalkyl. An example arylalkyl group is benzyl.

As used herein, “halo” or “halogen” includes fluoro, chloro, bromo, and iodo.

As used herein, “haloalkyl” refers to an alkyl group having one or more halogen substituents. Example haloalkyl groups include CF₃, C₂F₅, CHF₂, CCl₃, CHCl₂, C₂Cl₅, and the like.

As used herein, “haloalkenyl” refers to an alkenyl group having one or more halogen substituents.

As used herein, “haloalkynyl” refers to an alkynyl group having one or more halogen substituents.

As used herein, “haloalkoxy” refers to an -O-(haloalkyl) group.

As used herein, “amino” refers to NH₂.

As used herein, “alkylamino” refers to an amino group substituted by an alkyl group.

As used herein, “dialkylamino” refers to an amino group substituted by two alkyl groups that can be the same, or different from one another.

As used herein, “ether” refers to a group comprising an oxygen atom connected to two alkyl or aryl groups. As used herein, a “vinyl ether” refers to an ether comprising a carbon-carbon double bond bound to the oxygen atom.

As used herein, an “electron donating substituent” refers to a substituent that adds electron density to an adjacent pi-system, making the pi-system more nucleophilic. In some embodiments, an electron donating substituent has lone pair electrons on the atom adjacent to pi-system. In some embodiments, electron donating substituents have pi-electrons, which can donate electron density to the adjacent pi-system via hyperconjugation. Examples of electron donating substituents include O—, NR₂, NH₂, OH, OR, NHC(O)R, OC(O)R, aryl, and vinyl substituents.

As used herein, “unsaturated bond” refers to a carbon-carbon double bond or a carbon-carbon triple bond.

As used herein, a “monomer” is a substance, each of the molecules of which can, on polymerization, contribute one or more constitutional units in the structure of a macromolecule or polymer.

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x-x-y-z-x-y-y-z-y-z-z-z . . . or y-z-x-y-z-y-z-x-x . . . . An alternating random configuration can be: x-y-x-z-y-x-y-z-y-x-z . . . , and a regular alternating configuration can be: x-y-z-x-y-z-x-y-z . . . . A regular block configuration has the following general configuration: . . . x-x-x-y-y-y-z-z-z-x-x-x . . . , while a random block configuration has the general configuration: . . . x-x-x-z-z-x-x-y-y-y-y-z-z-z-x-x-z-z-z- . . . .

As used herein, the term “constitutional unit” of a polymer refers to an atom or group of atoms in a polymer, comprising a part of the chain together with its pendant atoms or groups of atoms, if any. The constitutional unit can refer to a repeat unit. The constitutional unit can also refer to an end group on a polymer chain. For example, the constitutional unit of polyethylene glycol can be —CH₂CH₂O— corresponding to a repeat unit, or —CH₂CH₂OH corresponding to an end group.

As used herein, the term “repeat unit” corresponds to the smallest constitutional unit, the repetition of which constitutes a regular macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

As used herein, the term “terminus” of a polymer refers to a constitutional unit of the polymer that is positioned at the end of a polymer backbone.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### Device

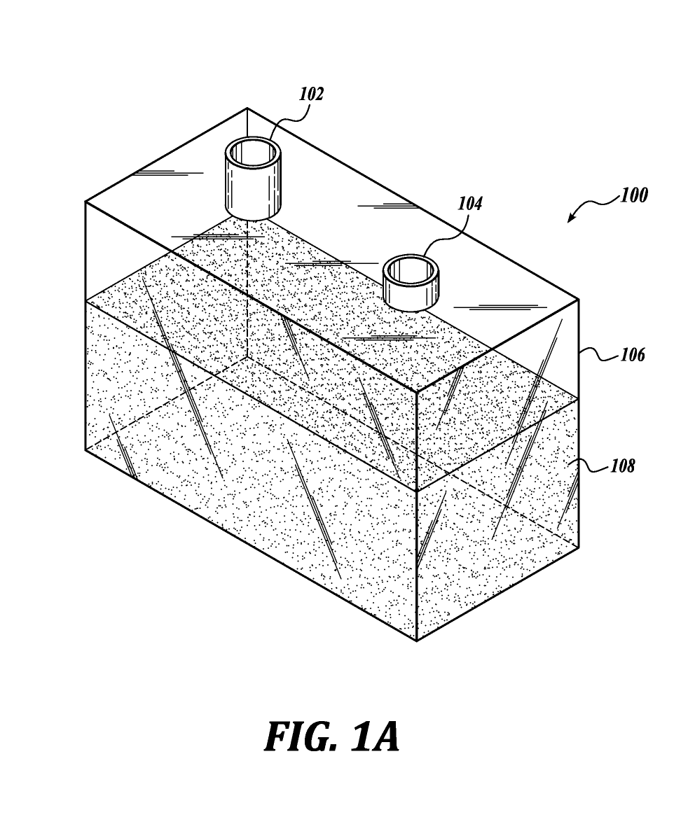

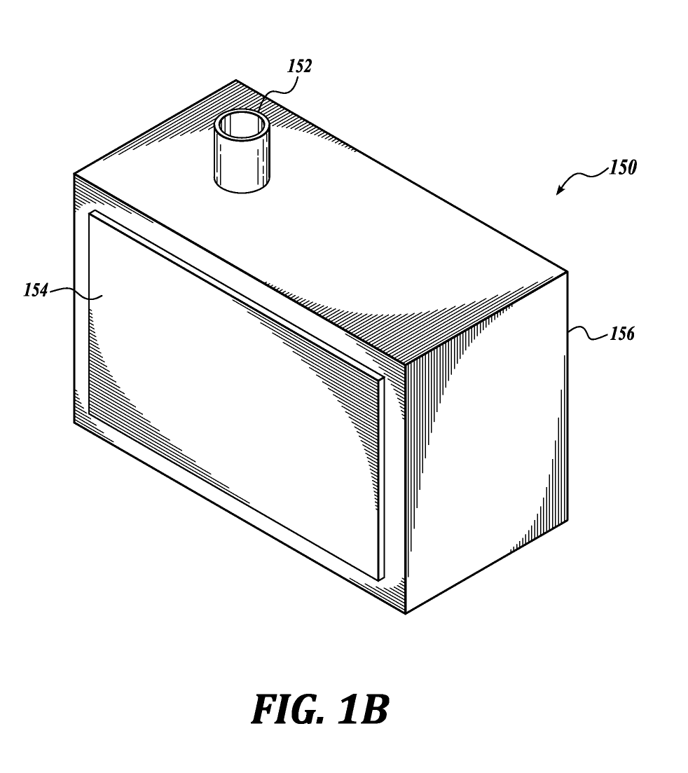

Referring to FIG. 1, a carbon dioxide-releasing device 100 has a chamber 106 that has a sealable aperture 102 that can receive a material or be used to withdraw a material from chamber 106. The material within chamber 106 can include a polymer 108, which can release carbon dioxide. Chamber 106 also includes a port 104 for releasing a gas (e.g., carbon dioxide) that is generated by the material (e.g., polymer 108) within chamber 106.

Chamber 106 can withstand an internal pressure buildup of from 2 atmospheres (e.g., from 3 atmospheres, from 4 atmospheres, from 5 atmospheres, from 6 atmospheres, from 7 atmospheres, from 8 atmospheres, or from 9 atmospheres) to 10 atmospheres (e.g., to 9 atmospheres, to 8 atmospheres, to 7 atmospheres, to 6 atmospheres, to 5 atmospheres, to 4 atmospheres, or to 3 atmospheres). In some embodiments, chamber 106 can withstand an internal pressure of 2 atmospheres, 3 atmospheres, 4 atmospheres, 5 atmospheres, 6 atmospheres, 7 atmospheres, 8 atmospheres, 9 atmospheres, or 10 atmospheres.

Chamber 106 can be made of any material, so long at the material of chamber 106 is non-reactive to the contents of the chamber (e.g., polymer 108, carbon dioxide, etc.) and to ambient conditions. The material of chamber 106 can be stable at a temperature of from −50° C. (e.g., from −30° C., from -10° C., from 0° C.) to 100° C. (e.g., to 80° C., to 60° C., or to 40° C.). For example, chamber 106 can be formed of plastic or stainless steel. Chamber 106 can be relatively rigid.

Sealable aperture 102 can be of any shaper or size, so long as it can be used to withdraw or to inject a material such as polymer 108, a catalyst, or an initiator. Aperture 102 can be sealed with a removable cap, or can be permanently sealed. In some embodiments, sealable aperture 102 can be a resealable flexible material, for example, a rubber material, such that sealable aperture 102 can remain sealed after a needle is inserted through the aperture and withdrawn. Sealable aperture 102 can be made of any material, so long as the material of aperture 102 is non-reactive to the contents of the chamber (e.g., polymer 108, carbon dioxide, etc.) and to ambient conditions. Sealable aperture 102 can be stable at a temperature of from −50° C. (e.g., from −30° C., from −10° C., from 0° C.) to 100° C. (e.g., to 80° C., to 60° C., or to 40° C.).

Port 104 can be permeable to a gas, such as carbon dioxide. In some embodiments, port 104 is a gas-permeable membrane. In certain embodiments, port 104 is a pressure release valve. Port 104 can be made of any material, so long as the material of port 104 is non-reactive to the contents of the chamber (e.g., polymer 108, carbon dioxide, etc.) and to ambient conditions. Port 104 can be stable at a temperature of from −50° C. (e.g., from −30° C., from −10° C., from 0° C.) to 100° C. (e.g., to 80° C., to 60° C., or to 40° C.).

In some embodiments, device 100 further includes a heating element, a cooling element, or a heating element and a cooling element (not shown). The heating and/or cooling element can be used regulate the temperature of device 100 and its contents, either by directly or indirectly heating or cooling device 100 and its contents. In some embodiments, the heating and/or cooling element is a phase change material. In some embodiments, device 100 includes a photovoltaic cell as a heating element.

Device 100 can be incorporated into, or be in close proximity to an insect trapping apparatus, such that a steady amount of CO₂ can be controllably released from the device to attract the insect.

As described above, chamber 106 can contain a polymer 108. In addition to polymer 108, in some embodiments, chamber 106 contains one or more of a solvent, a catalyst, and/or an oxidant. Each of these will be described in more detail below. In some embodiments, referring to FIG. 1B, a carbon dioxide-releasing device 150 has a chamber 156 that has a combined input and output port 152 that is configured to receive a material into chamber 156, to withdraw a material from chamber 156, and/or to release a gas (e.g., carbon dioxide) that is generated by the material (e.g., a carbon dioxide-releasing polymer, not shown) within chamber 156. Combined input and output port 152 can include, for example, a valve or a semi-permeable resealable membrane. The material within chamber 156 can include a carbon dioxide-releasing polymer (not shown). As shown in FIG. 1B, carbon dioxide-releasing device 150 includes a heating or cooling panel 154, which is in contact with chamber 156. Heating or cooling panel can provide temperature control for the contents of chamber 156. As described above for device 100, carbon dioxide-releasing device 150 can be incorporated into, or be in close proximity to an insect trapping apparatus, such that a steady amount of CO₂ can be controllably released from the device to attract the insect.

### Carbon Dioxide-Releasing Polymer

Chamber 106 can contain the carbon dioxide-releasing polymer 108 (referred to herein interchangeably as self-immolative polymer) dissolved in a solvent, suspended in a solvent, or neat (i.e., solvent-free). Examples of suitable solvents include water, dimethylsulfoxide, N,N-dimethylformamaide, alcohols (e.g., methanol, ethanol, 2-propanol), and/or toluene.

Carbon dioxide-releasing polymer 108 is a self-immolative polymer that releases carbon dioxide upon depolymerization. In some embodiments, the carbon dioxide-releasing polymer provides polymerizable monomers on release of carbon dioxide from the polymer. The polymerizable monomers can regenerate a carbon dioxide-releasing polymer on reaction with carbon dioxide and a polymerization catalyst.

Self-immolative polymer 108 is a stimuli-responsive polymer that can be activated by exposure to a stimulus to undergo a head-to-tail depolymerization and carbon dioxide release. The polymer includes a self-immolative polymer segment and a trigger moiety. The self-immolative polymer segment includes a head end, a tail end, and repeating units. Self-immolative polymers are described, for example, in U.S. application Ser. No. 14/650,221, herein incorporated by reference in its entirety.

In some embodiments, the self-immolative polymer continuously depolymerizes and releases carbon dioxide upon a single exposure to a stimulus (e.g., a polyurethane stimuli-responsive polymer). In certain embodiments, depolymerization of the self-immolative polymer and carbon dioxide release occur only during application of a stimulus, such that the depolymerization can be started and stopped depending on whether the stimulus is applied to the polymer (e.g., a polycarbonate stimuli-responsive polymer). In some embodiments, once the carbon dioxide has reached a certain pressure threshold within chamber 106, the depolymerization reaction can halt until the carbon dioxide pressure falls below the pressure threshold. The pressure threshold can be, for example, from 1 atmosphere (e.g., from 2 atmospheres, from 3 atmospheres, from 4 atmospheres, from 5 atmospheres, or from 6 atmospheres) to 7 atmospheres (e.g., to 6 atmospheres, to 5 atmospheres, to 4 atmospheres, to 3 atmospheres, to 2 atmospheres). In some embodiments, the pressure threshold is greater than 1 atmosphere (greater than 2 atmospheres, greater than 3 atmospheres, greater than 4 atmospheres, greater than 5 atmospheres, greater than 6 atmospheres) and/or 7 atmospheres or less (e.g., 6 atmospheres or less, 5 atmospheres or less, 4 atmospheres or less, 3 atmospheres or less, or 2 atmospheres or less).

In some embodiments, the stimulus is a predetermined temperature. For example, the trigger moiety can be heat-sensitive and therefore can be thermally activated. In some embodiments, the predetermined temperature is about 30° C., about 40° C., about 50° C., about 60° C., about 70° C., about 80° C., about 90° C., or about 100° C. The temperature can be continuously applied, intermittently applied, or applied at the beginning of a depolymerization reaction.

In some embodiments, the stimulus is an oxidant. The oxidant can be, for example, tetrabutylammonium periodate, molecular oxygen, copper (I) chloride, hydrogen peroxide, copper (II) sulfate, graphene, ceric sulfate, and/or an iron salt. In some embodiments, the iron salt is ferricyanide. In some embodiments, the oxidant is hemoglobin, horseradish peroxidase, a catalase, a urease, prostaglandin H synthase, and/or myeloperoxidase. In some embodiments, the oxidant is an electrochemical oxidation.

Referring to Scheme 1, in some embodiments, the trigger moiety is covalently bound to a terminus (e.g., the head end) of a self-immolative polymer segment. Upon activation of the trigger (e.g., thermal activation above a given threshold temperature, or activation by oxidation), the self-immolative polymer segment begins a sequential release of the repeating units and CO₂. In some embodiments, upon activation, the trigger decomposes to reveal an electron-rich functionality that can initiate a release of a first repeating unit adjacent to the trigger moiety. Release of the first repeating unit and CO₂ unmasks a subsequent electron rich functionality on a second repeating unit adjacent to the first repeating unit, which then initiates the release of the second repeating unit and CO₂ while unmasking yet another electron rich functionality on a third repeating unit adjacent to the second repeating unit. The repeating unit release process (e.g., a depolymerization) continues thus in a sequential manner, resulting in a successive release of repeating units and CO₂, and the progressive shortening of the self-immolative polymer chain with each iteration, until all repeating units are released (Scheme 1). Release of the repeating groups can occur in a directional manner, such as in a head to tail direction. An example of a self-immolative polymer triggering and depolymerization is shown in Scheme 1.

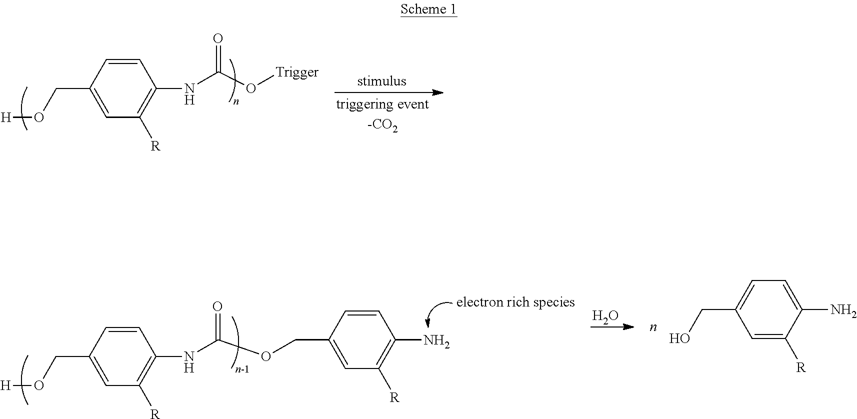

An electron-rich functionality can include lone pair electrons that can participate in nucleophilic attack or elimination (e.g., conjugated elimination) reactions. For example, the electron-rich functionality can include an amine (e.g., an unsubstituted amine, an alkylamine, a dialkylamine), a hydroxyl, a phenoxide or other alkoxide, a thiol, and/or a carboxylate group. The nucleophilic attack can occur intramolecularly, for example, within the self-immolative polymer segment itself to release repeating units by formation of a cyclic group (e.g., a cyclic urea).

As described above, the trigger moiety can be heat-sensitive. As used herein, “heat-sensitive” refers to a moiety that is decomposed upon exposure to a certain temperature, such as a physiological temperature or a temperature above a physiological temperature. In some embodiments, the trigger moiety includes a cycloaddition adduct. The cycloaddition adduct can include a [4+2] cycloaddition adduct (e.g., a Diels-Alder adduct) of a diene and a dienophile. Suitable diene and dienophiles are described, for example, in U.S. application Ser. No. 14/650,221, herein incorporated by reference in its entirety.

In some embodiments, cycloaddition adducts between carbamoylnitroso-containing molecules and various dienes are used for temperature-sensitive trigger moieties that can unmask an electron rich species. Referring to Scheme 2, cycloreversion of the adduct releases the carbamoylnitroso group which is then hydrolytically degraded to an electron rich group (e.g., an amine, an alkylamine, a dialkylamine).

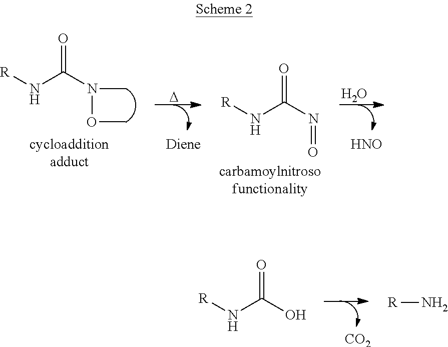

The self-immolative polymer can have two repeating units or more (e.g., 10 repeating units or more). Self-immolative polymer segments are described, for example, in Peterson et al., Controlled Depolymerization: Stimuli-Responsive Self-Immolative Polymers, Macromolecules 2012, 45, 7317-28. The self immolative polymer segment can be in the form of linear polymers or dendrimers, and adapted to facilitate release of small molecules pendant to the SIP main chain. The self-immolative polymer segment can include polyurethanes and/or polyethers. Examples of self-immolative polymers, their synthesis, and depolymerization mechanism are described, for example, in Peterson et al., Controlled Depolymerization: Stimuli-Responsive Self-Immolative Polymers, Macromolecules 2012, 45:7317-28; U.S. Patent Publication No. 2012/0259267; U.S. Patent Publication No. US2012/0270937; U.S. Patent Publication No. 2005/0271615; U.S. Patent Publication No. 2006/0269480; International Publication No. WO2011/038117; and International Publication No. WO2008/053479; the contents of each of which are herein incorporated in their entireties.

The self-immolative polymer segment can include optionally substituted repeating units. For example, prior to incorporation into the self-immolative polymer segment, the repeating unit can include an optionally substituted carbamate moiety, or an optionally substituted carbonate moiety.

In some embodiments, the repeating unit is

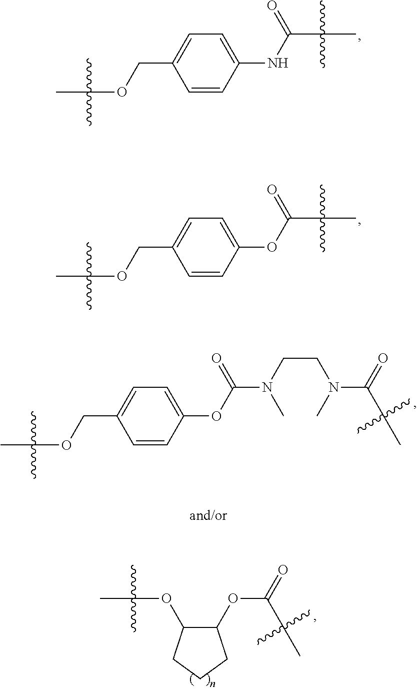

and/or substituted derivatives thereof, wherein n is 1, 2, 3, or 4. One or more repeating units can be optionally substituted with one or more (e.g., 1, 2, 3, 4, 5, or 6) substituent groups. The substituent group can include any group that does not interfere with the release of a given repeating unit or trigger moiety. For example, the substituent groups can be independently selected from halo, C₁₋₈ alkyl, C₁₋₈ haloalkyl, aryl, arylalkyl, C₁₋₈ alkoxy, heteroaryl, heteroarylalkyl, cycloalkyl, heterocycloalkyl, and OH, wherein said C₁₋₈ alkyl, C₁₋₈ haloalkyl, aryl, arylalkyl, C₁₋₈ alkoxy, heteroaryl, heteroarylalkyl, cycloalkyl, or heterocycloalkyl groups is optionally substituted with OH. In some embodiments, the one or more substituent groups are each independently selected from halo, C₁₋₈ alkyl, or aryl. In some embodiments, the substituent is a covalently bound therapeutic agent, such that the therapeutic agent is a pendant side chain on a given repeating unit.

In some embodiments, a portion of the repeating units of the self-immolative polymer segment is substituted. The substituted portion can be 10 mol % or more (e.g., 20 mol % or more, 40 mol % or more, 60 mol % or more, or 80 mol % or more) and/or 90 mol % or less (e.g., 80 mol % or less, 60 mol % or less, 40 mol % or less, or 20 mol % or less). For example, about 10 mol % (e.g., about 20 mol %, 40 mol %, 60 mol %, or 80 mol %) of the repeating units in the self-immolative polymer can be substituted.

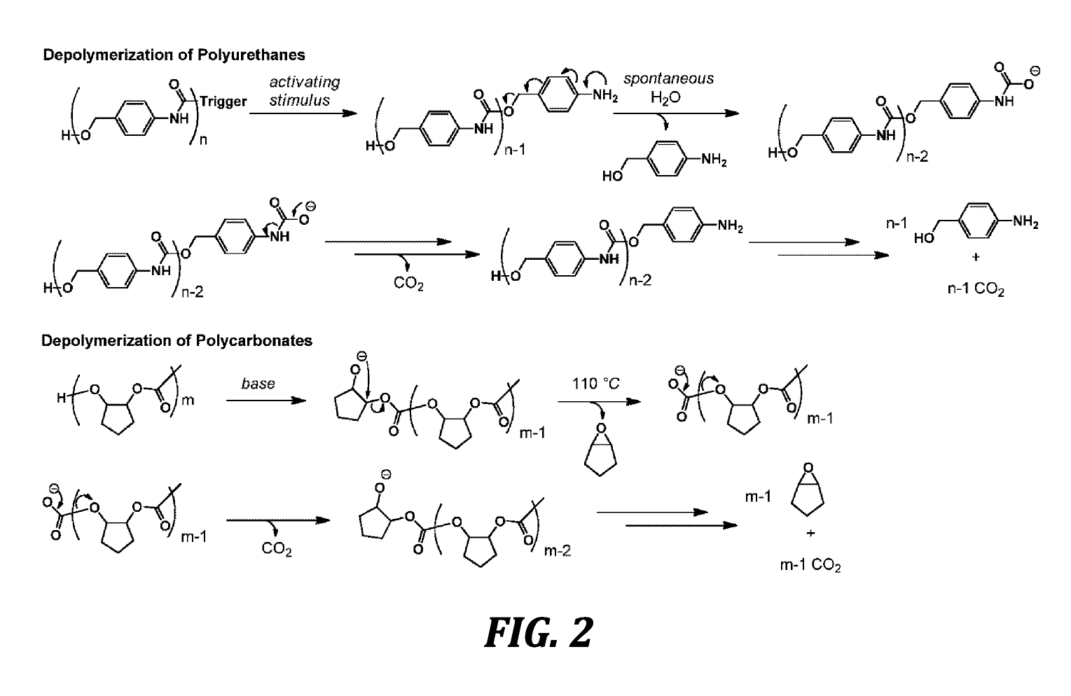

In some embodiments, the carbon-dioxide releasing polymer is a polyurethane, a polycarbonate, or copolymers thereof. A schematic illustration of the depolymerization of a representative polyurethane and a representative polycarbonate is shown, for example, in FIG. 2. In some embodiments, the carbon dioxide-releasing polymer is a block copolymer including a polyurethane block. In certain embodiments, the block copolymer further includes a polymer block selected from poly(ethylene glycol), poly(N,N-dimethylacrylamide), poly(vinylpyrrolidone), poly(vinyl alcohol), poly (N-(2-hydroxypropyl)methacrylamide), poly(divinylether-maleic anhydride), poly(-alkyl-2-oxazolines), xantham gum, pectin, and/or dextran.

### Catalyst

In some embodiments, chamber 106 further includes a catalyst. The catalyst is in contact with the carbon-dioxide releasing polymer and catalyzes the release of carbon dioxide from the polymer. In some embodiments, the catalyst catalyzes polymerization of monomers produced from the release of carbon dioxide from the carbon dioxide-releasing polymer.

In some embodiments, the catalysts are metal complexes, such as (salen)CrCl.

### Method of Use

In use, device 100 is loaded with polymer 108 and optionally a catalyst, and is exposed to a stimulus in the form of a predetermined temperature or an oxidant. The device can be placed in a location where carbon dioxide release is desired, such as a location where biting insects are to be trapped and/or killed. For example, carbon dioxide can be controllably released from a carbon dioxide source in device 100 in an environment frequented by an insect attracted to carbon dioxide, thereby attracting the insect to carbon dioxide. The carbon dioxide source can be a carbon dioxide-releasing polymer.

In some embodiments, the carbon dioxide release can be terminated and/or restarted. For example, as described previously, depending on the stimuli-responsive polymer, the stimuli-responsive polymer can continuously depolymerize and release carbon dioxide upon a single exposure to a stimulus (e.g., a polyurethane stimuli-responsive polymer); or depolymerization of the stimuli-responsive polymer and carbon dioxide release can occur only during application of a stimulus, such that the depolymerization can be started and stopped depending on whether the stimulus is applied to the polymer (e.g., a polycarbonate stimuli-responsive polymer). In some embodiments, once the carbon dioxide has reached a certain pressure threshold within chamber 106, the depolymerization reaction can be halted until the carbon dioxide pressure falls below the pressure threshold. The pressure threshold can be, for example, from 1 atmosphere (e.g., from 2 atmospheres, from 3 atmospheres, from 4 atmospheres, from 5 atmospheres, or from 6 atmospheres) to 7 atmospheres (e.g., to 6 atmospheres, to 5 atmospheres, to 4 atmospheres, to 3 atmospheres, to 2 atmospheres). In some embodiments, the pressure threshold is greater than 1 atmosphere (greater than 2 atmospheres, greater than 3 atmospheres, greater than 4 atmospheres, greater than 5 atmospheres, greater than 6 atmospheres) and/or 7 atmospheres or less (e.g., 6 atmospheres or less, 5 atmospheres or less, 4 atmospheres or less, 3 atmospheres or less, or 2 atmospheres or less).

In some embodiments, the carbon dioxide is released at a constant rate over a period of from about 1 day to about 200 days (e.g., 1 day to 120 days, 5 days to 200 days, 5 days to 120 days, 1 day to 180 days, 30 to 120 days, or 30 to 180 days). As used herein, “constant rate” refers to a pseudo zero order release, where the rate is apparently independent of the reactant concentrations. For example, the rate of the reaction can be about equal to the rate constant of the reaction. In some embodiments, the rate can vary by less than 20 percent (e.g., less than 10 percent, or less than 5 percent) for at least 75% of the total reaction or depolymerization time of the carbon dioxide-releasing polymer, for example, once the release rate has stabilized over the course of the depolymerization of the carbon dioxide-releasing polymer.

The release rate and duration of the carbon dioxide from the carbon dioxide-releasing polymer in device 100 can be useful in, for example, insect traps where the self-sustaining release of carbon dioxide is a desirable feature. Carbon dioxide release can be controlled, for example, by controlling the temperature, the amount of an oxidant, and/or the carbon dioxide pressure in device 100. The temperature and/or the carbon dioxide pressure can be programmable and/or variable.

### Rechargeable Devices

As described above, in some embodiments, the carbon dioxide-releasing polymer provides polymerizable monomers on release of carbon dioxide from the polymer. The polymerizable monomers can regenerate a carbon dioxide-releasing polymer on reaction with carbon dioxide and a polymerization catalyst. Thus, a device including such a carbon dioxide-releasing polymer can be recharged once the polymer has been depolymerized to a desired amount, by repolymerizing the polymerizable monomers to form a carbon dioxide-releasing polymer.

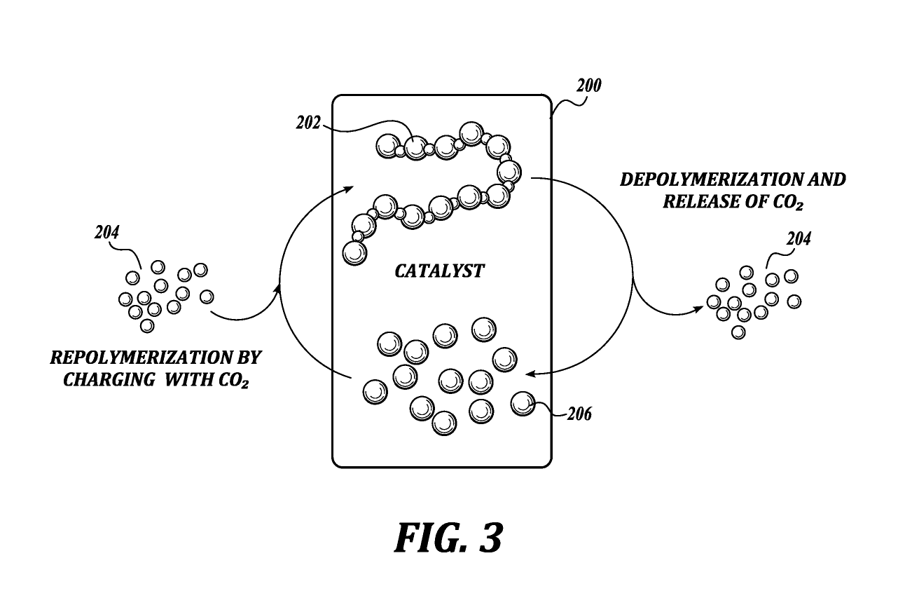

Referring to FIG. 3, a carbon dioxide-releasing polymer 202 in a device 200 can undergo depolymerization to form polymerizable monomers 206 and release carbon dioxide 204 from the device. The depolymerization can occur with or without a catalyst. Upon charging the device with carbon dioxide and in the presence of the catalyst, both of which can be loaded into the device via a sealable aperture, polymerizable monomers 206 (e.g., an epoxide-containing monomer, such as 6-oxabicyclo[3.1.0]hexane) can repolymerize to form a carbon dioxide-releasing polymer (e.g., a polycarbonate). The repolymerization reaction can take place with, or without heating the reaction mixture. The repolymerized polymer can have the same repeating unit structure as the initial carbon dioxide-releasing polymer 202. However, in some embodiments, the repolymerized polymer has a different weight average molecular weight (e.g., a higher weight average molecular weight, or a lower weight average molecular weight) and/or a different polydispersity (e.g., a higher polydispersity or a lower polydispersity) than the initial carbon dioxide-releasing polymer 202. In some embodiments, the repolymerized polymer has a lower weight average molecular weight and/or a higher polydispersity than the initial carbon dioxide-releasing polymer 202.

In some embodiments, rather repolymerizing a monomer within a device by charging the device with carbon dioxide and a catalyst, the polymerizable monomer (e.g., aminobenzyl alcohol) can be isolated from device 200 (e.g., via a sealable aperture) and repolymerized outside of the device to provide a carbon dioxide-releasing polymer (e.g., a polyurethane), which can then be loaded into an empty device for carbon dioxide release.

In some embodiments, a carbon dioxide-releasing polymer 202, such as a copolymer, can undergo depolymerization to provide more than one type of polymerizable monomers and carbon dioxide. The polymerizable monomers can be repolymerized within a device, or can be isolated from the device and repolymerized outside the device, in the presence of carbon dioxide and a catalyst, to provide a carbon dioxide-releasing polymer.

In some embodiments, device 200 can be recharged (i.e., carbon dioxide-releasing polymer 202 can be repolymerized) numerous times (e.g., 2 times, 5 times, 10 times, 20 times, or 30 times) before the device 200 is discarded or otherwise decommissioned.

The following examples are provided to illustrate, not limit, the invention.

Example 1 provides a depolymerization of a carbon dioxide-releasing polyurethane using an oxidative trigger. Example 2 provides a depolymerization of a carbon dioxide-releasing block copolymer using a heat trigger.

### EXAMPLES

### Example 1

### Depolymerization of a Polyurethane

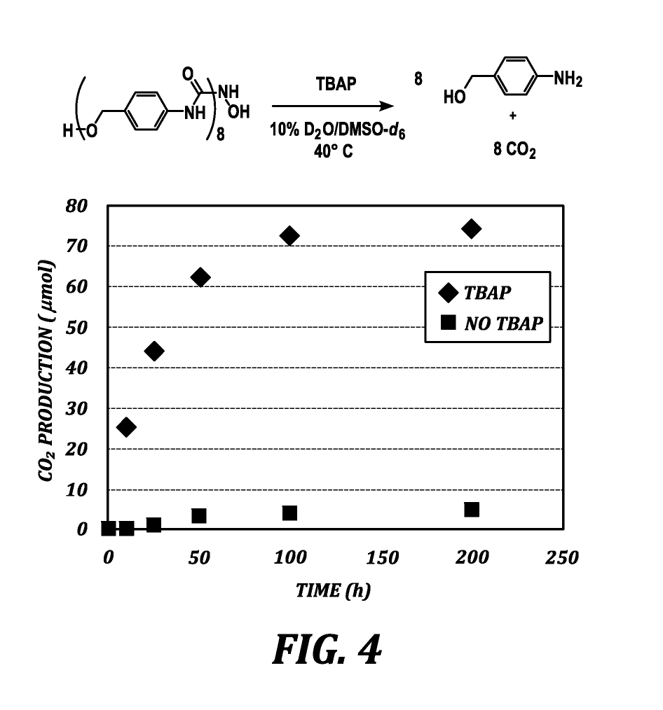

Several CO₂ release profiles were demonstrated with polyurethane-based self- immolative polymers by varying a depolymerization trigger and/or temperature. A hydroxyurea functionalized self-immolative polymer which is sensitive to oxidative conditions was synthesized. Tetrabutylammonium periodate (TBAP) was used to oxidize the hydroxyurea end group to an amine, which then initiated the depolymerization (FIG. 4). A release rate of ca. 1.2 μmol of CO₂ per hour for the first 50 hours was observed for a 12 μmol sample of self-immolative polymer in wet DMSO (see FIG. 4). The amount of CO₂ produced greatly tapered off after 100 h. The amount of CO₂ produced was determined by following the loss of the polymer proton signals by ¹H NMR compared to an internal standard. In the absence of the TBAP, negligible (>5% degradation of SIP) production of CO₂ is observed, demonstrating the relative stability of the polymer to nontriggering conditions.

### Example 2

### Depolymerization of a Block Copolymer

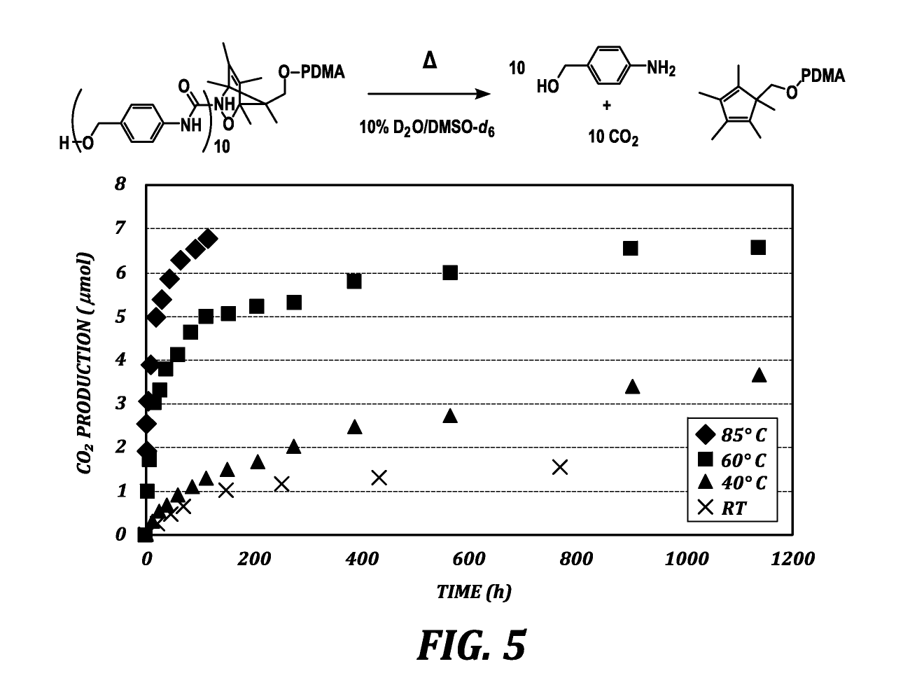

Thermally activated triggers are activated without the addition of reagents. As shown in FIG. 5, the CO₂-releasing polymer can include thermally-triggered self-immolative diblock copolymers. Amphiphilic diblock copolymers with oxazine thermal triggers as the joining functionality between the self-immolative polymer and poly(N,N-dimethyl acrylamide) (PDMA) blocks were prepared. The diblock copolymers are preferred in certain cases because they can be easily purified.

Upon heating the diblock, the oxazine undergoes a retro-cyclization that releases a diene and a carbamoylnitroso group that degrades down to the free amine that initiates the depolymerization process. Compared to the oxidative activation of the self-immolative polymer, thermal activation occurs much more slowly (at 40° C.) and thus the CO₂ release times are extended (see FIG. 5). This process is highly temperature dependent, however, giving the opportunity to tune the release rate.

The depolymerization and release of CO₂ at several temperatures was studied (starting with 0.7 μM of diblock polymer with a SIP DP of 10). At 85° C. the polymer degrades very quickly, reaching full depolymerization in about 115 h. At the lower temperatures studied the time for full depolymerization of the polymer (and thus full release of CO₂) is at least 10 times longer.

While illustrative embodiments have been illustrated and described, it will be appreciated that various changes can be made therein without departing from the spirit and scope of the invention.

The embodiments of the invention in which an exclusive property or privilege is claimed are defined as follows:

1. A carbon dioxide-releasing device, comprising:
a chamber having a sealable aperture for receiving a first material;
a carbon dioxide-releasing polymer disposed within the chamber; and
a port for releasing a carbon dioxide generated by the carbon dioxide-releasing polymer from the chamber.

2. The device of claim 1, wherein the carbon dioxide-releasing polymer is a self-immolative polymer and the gas is carbon dioxide.

3. The device of claim 1, wherein the chamber further comprises a catalyst.

4. The device of claim 3, wherein the catalyst is in contact with the carbon-dioxide releasing polymer and catalyzes the release of carbon dioxide from the polymer.

5. The device of claim 3, wherein the catalyst catalyzes polymerization of monomers produced from the release of carbon dioxide from the carbon dioxide-releasing polymer.

6. The device of claim 1, wherein the carbon dioxide-releasing polymer provides polymerizable monomers on release of carbon dioxide from the polymer.

7. The device of claim 1, wherein the polymerizable monomers regenerate a carbon-dioxide releasing polymer on reaction with carbon dioxide and a polymerization catalyst.

8. The device of claim 1, wherein the carbon dioxide-releasing polymer comprises repeating units comprising an optionally substituted carbamate moiety, or an optionally substituted carbonate moiety.

9. The device of claim 1, wherein the carbon dioxide-releasing polymer is selected from a polyurethane, a polycarbonate, or copolymers thereof.

10. The device of claim 1, wherein the carbon dioxide-releasing polymer is a block copolymer comprising a polyurethane block.

11. The device of claim 10, wherein the block copolymer further comprises a polymer block selected from poly(ethylene glycol), poly(dimethylacrylamide), poly(vinylpyrrolidone), poly(vinyl alcohol), poly (N-(2-hydroxypropyl)methacrylamide), poly(divinylether-maleic anhydride), poly(2-alkyl-2-oxazolines), xantham gum, pectin, dextran, and any combination thereof.

12. The device of claim 1, wherein the carbon dioxide-releasing polymer disposed in the chamber is dissolved in a solvent, suspended in a solvent, or is solvent free.

13. The device of claim 1, wherein the carbon dioxide-releasing polymer releases carbon dioxide upon exposure to a stimulus.

14. The device of claim 13, wherein the stimulus is a predetermined temperature or and an oxidant.

15. The device of claim 14, wherein the oxidant is selected from the group consisting of tetrabutylammonium periodate, molecular oxygen, copper (I) chloride, hydrogen peroxide, copper (II) sulfate, graphene, ceric sulfate, ferricyanide, and any combination thereof.

16. The device of claim 14, wherein the oxidant is selected from the group consisting hemoglobin, horseradish peroxidase, a catalase, a urease, prostaglandin H synthase, myeloperoxidase, and any combination thereof.

17. The device of claim 14, wherein the oxidant is an electrochemical oxidation.

18. The device of claim 1 further comprising a heating element, a cooling element, or a heating element and a cooling element.

19. The device of claim 1, wherein the chamber is adapted to withstand an internal pressure of 2 to 10 atmospheres.

20. The device of claim 1, wherein the port is a gas-permeable membrane.

21. The device of claim 1, wherein the port is a pressure release valve.

22. A method for making a carbon dioxide-releasing device, comprising:
disposing a carbon dioxide-releasing polymer in a chamber having a sealable aperture for receiving a first material and a port for releasing a gas generated by the carbon dioxide-releasing polymer from the chamber.

23. The method of claim 22 further comprising disposing a catalyst in the chamber.

24. The method of claim 22, wherein the catalyst is in contact with the carbon-dioxide releasing polymer and catalyzes the release of carbon dioxide from the polymer.

25. The method of claim 22, wherein the catalyst catalyzes polymerization of monomers produced from the release of carbon dioxide from the carbon dioxide-releasing polymer.

26. The method of claim 1, wherein the device further comprises a heating element, a cooling element, or a heating element and a cooling element.

27. The method of claim 1, wherein the chamber is adapted to withstand an internal pressure of 2 to 10 atmospheres.

28. The method of claim 1, wherein the port is a gas-permeable membrane.

29. The method of claim 1, wherein the port is a pressure release valve.

30. A method of attracting an insect that is attracted to carbon dioxide to a carbon dioxide source, comprising:
controllably releasing carbon dioxide from a carbon dioxide source in an environment frequented by an insect attracted to carbon dioxide, thereby attracting the insect to carbon dioxide, wherein the carbon dioxide source is a carbon dioxide-releasing polymer.

31. The method of claim 30, wherein carbon dioxide is released at a constant rate over a period of from about 1 day to about 200 days.

32. The method of claim 30, wherein releasing carbon dioxide can be terminated and restarted.

33. The method of claim 30, wherein the carbon dioxide source is the device of claim 1.
